(19) United States
(12) Patent Application Publication
(10) Pub. No.: US 2026/0246498 A1
(43) Pub. Date: Aug. 20, 2026

(54) RECONFIGURABLE INTELLIGENT SURFACE WITH ORIENTATION-AWARE UNIT CELLS

(71) Applicant: British Telecommunications Public Limited Company, London (GB)

(72) Inventors: Fraser BURTON, London (GB); Malcolm HUBERT, London (GB); Aaron WALKER, London (GB)

(21) Appl. No.: 19/471,915

(22) PCT Filed: Mar. 7, 2024
(86) PCT No.: PCT/EP2024/056062

§ 371 Date: Oct. 2, 2025

(30) Foreign Application Priority Data
Apr. 4, 2023 (EP) 23166608.2

(51) Int. Cl. H04B 7/04; H01Q 15/00

(52) U.S. Cl. CPC H04B 7/04013; H01Q 15/0066

(57) ABSTRACT

The present disclosure relates to a reconfigurable intelligent surface (RIS). A RIS is provided that can be conformed to a non-planar surface, the RIS including a plurality of RIS unit cells, a plurality of accelerometers, each accelerometer configured to detect accelerometer data for at least one of the RIS unit cells; and a controller configured to determine an operating condition of the RIS based on the detected accelerometer data of the RIS unit cells and to adjust one or more operational parameters based on the operating condition. Also provided is a method of operating such a RIS, wherein each RIS unit cell includes a dedicated accelerometer configured to detect the accelerometer data of the RIS unit cell.

### PRIORITY CLAIM

The present application is a National Phase Entry of PCT Application No. PCT/EP2024/056062, filed Mar. 7, 2024, which claims priority from EP Application No. 23166608.2, filed Apr. 4, 2023, each of which is hereby fully incorporated herein by reference.

### TECHNICAL FIELD

The present disclosure relates to a reconfigurable intelligent surface (RIS). In particular, the present disclosure relates to a RIS, comprising orientation-aware unit cells, that can be conformed to a non-planar surface and a corresponding method.

### BACKGROUND

A Reconfigurable Intelligent Surface (RIS) is an inexpensive adaptive thin composite material sheet, which can cover parts of walls, buildings, ceilings, etc., and is capable of modifying radio waves impinging upon it, or passing through it, in ways that can be programmed and controlled by using external stimuli. This technology has been described by a wide variety of names including: large intelligent surfaces, reconfigurable reflect arrays, reconfigurable intelligent surfaces, intelligent reflecting surfaces, software-controlled metasurfaces, and programmable surfaces.

A RIS used for wireless radio frequency (RF) communications is usually positioned between a transmitter and a receiver. The RIS is generally placed either mid-way between the transmitter and the receiver to overcome a blocked line-of-sight, or alternatively it can be placed close to either the transmitter or receiver in order to minimize path-loss. The RIS can operate in reflection and may comprise a rigid array of diode-controlled unit cells mounted on printed circuit boards connected to a separate controller. The unit cell separation determines the RF frequency of operation and the controller determines the reflective characteristics of the surface. The RIS can also operate in transmission using transparent unit cells and the unit cells themselves do not need to be diode-based but can use a wide range of metasurfaces. Generally, therefore, a RIS operates to produce a change in phase of electromagnetic waves incident on the RIS unit cell or the electromagnetic waves may pass through the RIS and their phases are altered during passage through.

### SUMMARY

Generally the disclosure relates to a Reconfigurable Intelligent Surface (RIS) having a plurality of unit cells and an accelerometer associated with each unit cell of the plurality of unit cells to provide orientation information.

According to a first aspect, a reconfigurable intelligent surface (RIS) is provided that can be conformed to a non-planar surface, the RIS comprising: a plurality of RIS unit cells, a plurality of accelerometers, each accelerometer configured to detect accelerometer data for at least one of the RIS unit cells; and a controller configured to determine an operating condition of the RIS based on the detected accelerometer data of the RIS unit cells and to adjust one or more operational parameters based on the operating condition, wherein each RIS unit cell comprises a dedicated accelerometer configured to detect the accelerometer data of said RIS unit cell.

Optionally the RIS may be configured to operate at radio frequency (RF).

Optionally the plurality of accelerometers are configured to measure an initial orientation of each of the plurality of RIS unit cells and a subsequent orientation of each of the plurality of RIS unit cells; and the controller is configured to determine a change in operating condition based on a change in orientation of at least some of the RIS unit cells and to adjust one or more operational parameters to compensate for the change in orientation.

Optionally the controller is configured to determine an operating condition of the RIS by determining when the velocities of the unit cells are substantially equal and therefore indicating that the RIS is conformed to a non-planar surface that is static or moving with constant velocity.

Optionally the controller is configured to determine an operating condition of the RIS by determining when the velocities of a first subset of the unit cells are substantially equal to one another and determining when the velocities of a second subset of the unit cells, consisting of unit cells not found in the first subset, are different to the velocities of the unit cells in the first subset, therefore indicating that the RIS is partially attached to a non-planar surface.

Optionally the controller is configured to determine an operating condition of the RIS by determining when the relative orientation of the unit cells stays the same and determining when there is a distribution of velocity changes across the unit cells therefore indicating that the RIS is mounted on a non-planar surface that is changing orientation.

Optionally the controller is configured to determine an operating condition of the RIS by determining when an initially calculated relative orientation of the unit cells is changing, indicating that the RIS is distorting.

Optionally the controller is configured to adjust the phase shift distribution across the RIS based on the determined operating condition of the RIS.

Optionally the controller is configured to determine the adjustment to the one or more operational parameters by looking up pre-determined settings based on the detected accelerometer data.

Optionally the predetermined settings are determined using machine learning.

Optionally the machine learning is performed based on feedback from a receiver that is arranged to receive a transmission from an antenna on which the RIS is mounted, the feedback indicating whether performance of the antenna is improved.

Optionally each RIS unit cell is hinged with at least one neighboring RIS unit.

Optionally the RIS further comprises a plurality of RIS unit sockets, each RIS unit socket configured to receive a RIS unit cell of the plurality of RIS unit cells, wherein a shape of the RIS unit socket and a shape of the RIS unit cell are configured such that the RIS unit cell extends to a periphery of the RIS unit socket, and wherein the plurality of RIS unit cells are removable.

Optionally the operational parameters (also referred to as operating parameters) are made by the controller in response to the accelerometer information it is receiving. Each unit cell may have at least one (and sometimes several) control voltages applied to it by the controller. Changes to these control voltages can be made to adjustment the operating parameters”. Given a certain set of control voltages, this determines the surface impedance, causing each unit cell to reflect an incident signal with a certain phase and amplitude, which will coherently combine with the reflections from all the other unit cells to create the desired reflected pattern.

Optionally the RIS is configured to be fixed to an antenna or antenna dish surface at one or more points around the edge of the non-planar antenna structure. For example, the RIS may be attached at a plurality of clamping points by clamps around the edge of the structure to which it is to be conformed. The cells at or near the clamping points can be detected based on detected accelerometer data indicating that they are not moving relative to neighboring cells, which will also be clamped. Clamped unit cells will all show substantially identical velocity and orientation changes. Unclamped unit cells may vibrate and ripple to some degree.

Optionally the plurality of accelerometers each comprises an accelerometer integrated circuit configured to provide a digital signal comprising: rate of change of velocity on 3-axis and inclination of the accelerometer circuit itself (and an immediate structure that it is affixed to).

Optionally a data bus is provided in the RIS to address each unit cell from the controller instead of point-to-point connections. The wiring pattern may extend out concentrically from the center of the framework, both to enable the wiring to be extended for use on larger structures, such as dishes, and to ensure some ongoing functionality can be preserved in the event of a wiring breakage. Keeping the physical support and wiring in a flexible framework distinct from the active electronics in each unit cell is intended to reduce the complexity and cost of the RIS, as well as making it more rugged and easier to repair.

According to a second aspect an antenna is provided comprising a non-planar antenna surface; and the RIS of the first aspect, wherein the RIS conforms to the non-planar antenna surface.

According to a third aspect a method of controlling the antenna of the second aspect is provided comprising controlling the RIS to improve antenna performance.

Optionally the method of controlling the antenna of the second aspect comprises controlling the RIS to compensate for motion of the antenna based on the detected orientation of each RIS unit.

According to a fourth aspect, a computer program is provided that, when executed on a processor of an antenna according to the second aspect, causes it to carry out the method according to the third aspect.

### BRIEF DESCRIPTION OF THE DRAWINGS

The disclosure will be further described, by way of example only, with reference to the accompanying drawings, in which:

FIG. 1 illustrates schematic diagram 100 showing an exemplary reconfigurable intelligent surface (RIS) conformed on a surface of a dish antenna.

FIG. 2a illustrates a schematic illustration 200 of a unit cell of RIS in a top-side view and under-side view and framework wells for holding the unit cells in place.

FIG. 2b illustrates exemplary connections between the unit cell and the corresponding framework well for positioning the unit cell.

FIG. 3 illustrates a schematic illustration 300 of an accelerometer included in a unit cell of a RIS in an under-side view and an exemplary configuration of the accelerometer in the RIS framework.

FIG. 4 illustrates a schematic illustration 400 of an antenna and a flexible RIS conformed to the surface of the antenna.

FIG. 5 illustrates a flowchart 500 showing operations 501 to 505 of a control algorithm and including programming phases of the RIS based on accelerometer data detected at one or more unit cells.

FIG. 6 illustrates different operational modes of using the RIS conformed on a surface of a dish antenna.

### DETAILED DESCRIPTION

Embodiments and related technology helpful for understanding and implementing the embodiments will now be described with reference to the Figures. The same or similar reference numerals are used to refer to the same or similar components across different Figures.

A RIS provided according to any embodiment is comprised of unit cells. The unit cells may be subwavelength. For example, the cells may be between one tenth and half a wavelength in size, the wavelength being dependent upon the frequency of operation which, for example, may be radio frequency. Due to the sub-wavelength scale, the surface of the RIS will respond to the incident RF signal as a smoothly varying phase gradient rather than discrete unit cells. The RIS includes a controller that is configured to change the electrical or magnetic properties of individual elements, reducing the amplitude of reflection, shifting the phase change on reflection or the polarization on reflection. The RIS then acts as essentially a reflective phased array.

Optionally, the RIS controller may include a PIN diode or varactor-diode-based programmable metasurface. The aim is generally to enable large phase shifts from each cell while minimizing amplitude shifts, allowing beam control without introducing losses, thereby achieving high antenna gain and wide-angle steering.

An incident RF signal will undergo a phase shift and attenuation upon reflection based on the surface properties of the RIS on a length scale of approximately one RF wavelength. The structure of the RIS immediately below the surface should enable the variation in the surface impedance (e.g. by providing a control voltage to a varactor diode in each unit cell) and should also hold each unit cell in place.

A flexible and conformal RIS can be placed over a non-planar surface, such as an internal surface of a conventional parabolic dish antenna. In this case, the RIS may be designed to overlay a pre-existing parabolic antenna dish and is constructed from unit cells held in a flexible framework. The design of unit cells' shape, size and distribution will contribute to the frequency response and beam-shaping of the antenna.

The RIS may be configured to have a flexible structure such that it can be conformed to a non-planar surface. An orientation of each unit cell may shift depending on how the RIS has been fitted and on the underlying surface itself, such as when the flexible RIS is positioned multiple times over multiple different surfaces. Due to the conformal property of the RIS, the RIS unit cells may change their orientation along with a motion or vibration of the underlying non-planar surface. Such orientational changes may indicate a change in operational conditions of the RIS. The changes should therefore be monitored and processed by the RIS controller, in order to compensate for any effect on the reflection characteristics.

Therefore, an orientation awareness of the RIS and a corresponding adjustment or reconfiguration of the RIS may be important to maintain desired reflection characteristics. The structure of the RIS immediately below the surface should be configured to provide orientation data of each unit cell to optimize or continuously re-optimize a phase shift distribution across the RIS.

This may be achieved by including accelerometers in the plurality of RIS unit cells. Accelerometers are well known devices used, for example, in modern smart phones and tablets. The accelerometer is an electromechanical device that measures a force of acceleration caused by movement, gravity or vibration. The sensor tracks the different motions like shaking, tilting, swinging, and rotating.

Embodiments may provide a flexible and easily-installed RIS using a plurality of accelerometers for the plurality of RIS unit cells to provide orientation awareness with rigid multi-use implementation to compensate for any change in operational conditions and maintain desired reflection characteristics of the RIS.

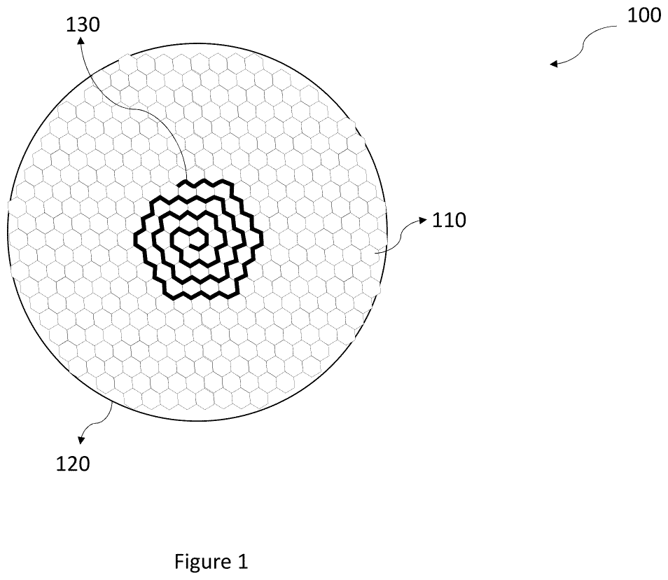

FIG. 1 is a schematic diagram 100 showing an exemplary reconfigurable intelligent surface (RIS) 110 conformed to a non-planar surface 120. The RIS 110 may comprise a plurality of unit cells arranged in a flexible framework.

Optionally an internal wiring pattern 130 may be used, extending out concentrically from the center of the framework. Such a wiring pattern may enable the wiring to be extended for use on larger surfaces, such as larger dishes, and may also ensure ongoing functionality can be preserved in the event of a wiring breakage.

Optionally the flexible framework of RIS 110 may be printed, such as using three-dimensional (3D) printing.

The RIS 110 is conformed to the non-planar surface 120. Conforming to the surface is possible because the RIS is flexible. Such flexibility may be achieved by each of the RIS unit cells being connected to other RIS unit cells in a flexible manner, for example as described below.

In use, the RIS may be positioned between a transmitter and a receiver for wireless RF communications. The RIS may be placed either mid-way between the transmitter and the receiver to overcome a blocked line-of-sight, or close to either the transmitter or receiver in order to minimize path-loss. Generally, the unit cell separation may determine the RF frequency of operation and the controller may determine the reflective characteristics of the surface. In some embodiments, the RIS may also operate in transmission.

Each unit cell of the plurality of unit cells in the RIS may be monitored to determine its ability to change its electrical or magnetic property that causes the change in phase of electromagnetic waves received at the RIS unit cell. This monitoring may be implemented within each unit cell, by a device or controller within the RIS or external to the RIS.

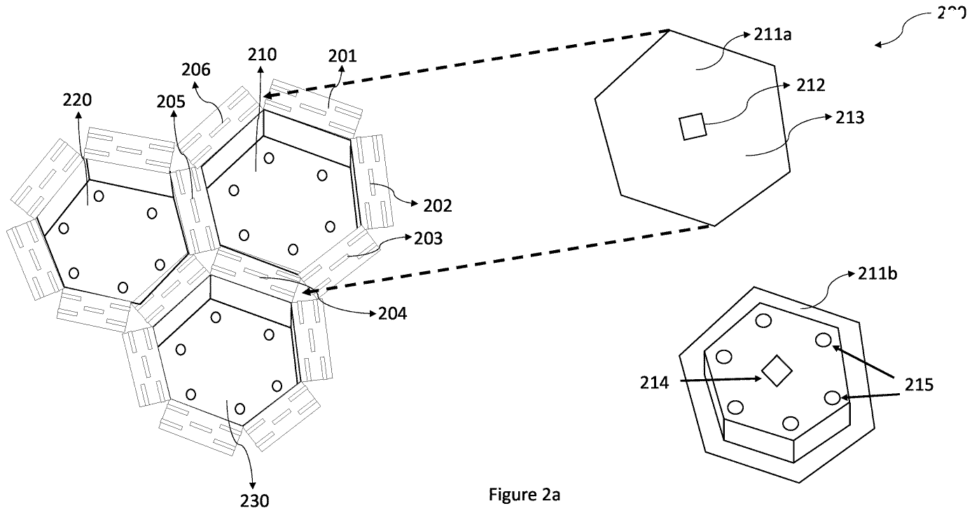

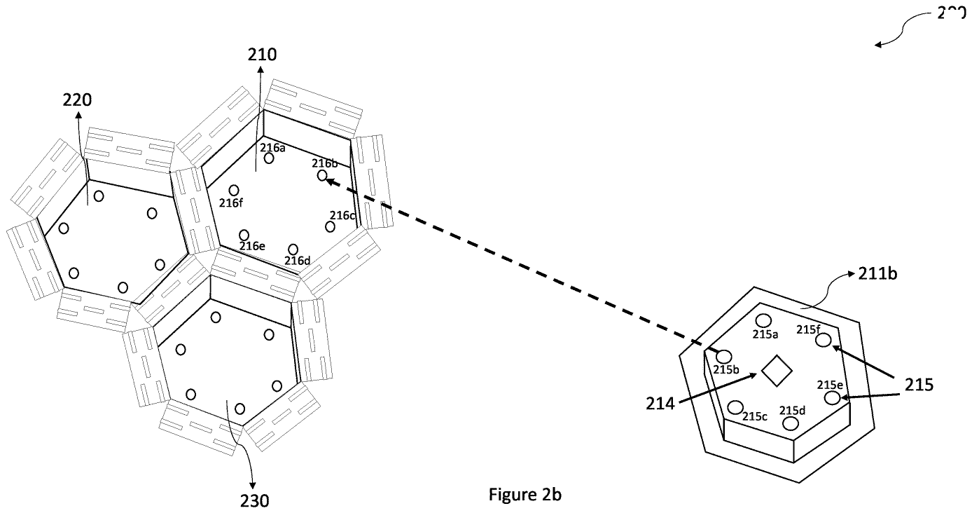

FIGS. 2a and 2b are schematic illustrations showing an example of individual unit cells and a framework for securing corresponding unit cells in place.

The physical support and wiring in the flexible framework are preferably kept distinct from the active electronics in each unit cell. This reduces the complexity and cost of the RIS, as well as making it more rugged and repairable.

Optionally hexagonal-shaped unit cells may be formed in the flexible framework. The hexagonal shape may be selected because it is a convenient form to produce with modern 3D printing methods and offers enough degrees of freedom to fit well on an arbitrary smooth surface, such as following a conformal shape of a pre-existing dish antenna. However, the unit cells and framework may be of any shape other than hexagonal shape.

Optionally, the unit cells may be connected by “living” hinges, also known as integral hinges. For example the hinge may be a thin flexible hinge made from the same material as the two rigid pieces it connects.

FIG. 2a shows an example unit cell 211 when it is viewed from a top side 211a and from a bottom side 211b. The unit cell 211 may be placed into a well 210 of the flexible framework, wherein the well 210 has two neighboring wells 220 and 230. The well 210 may have more neighboring wells which may not be shown in FIG. 2a. Each well may be connected to its respective neighboring wells through “living” hinges as described above. As shown in FIG. 2a, the hexagonal well 210 may comprise six hinges, one at each side, namely hinges 201, 202, 203, 204, 205 and 206. The well 210 may be connected to the well 220 through the hinge 205 and may be connected to the well 230 through the hinge 204.

As shown in FIG. 2a, the top-side unit cell 211a may include a diode 212 connected to a patterned conductive surface 213 on a layered dielectric background. In some embodiments, the diode for each unit cell may be a PIN diode or a varactor diode. The bottom-side unit cell 211b may include a microprocessor 214 connected to the unit cell and a plurality of electrical contacts 215 distributed across the bottom side of the unit cell.

The unit cell separation may determine the RF frequency of operation and the controller connected to the plurality of unit cells may determine the reflective characteristics of the surface of the RIS. When in operation, incident RF signals may undergo a phase shift and attenuation upon reflection based on the surface properties of the RIS. Specifically, when an RF signal at an intended wavelength is incident on the unit cells, there may be an oscillating electric field (e.g. referred to as an incident electric field) with a certain magnitude, polarization and phase. The incident RF signal may be reflected by the unit cells which results in a different magnitude, polarization and phase. A reflected electric field may then be produced by a movement of the electrons trapped on the surface of the conductive surfaces of the unit cells as they are pushed around the unit cells by the incident electric field. This movement of trapped electrons may be changed by turning on diodes, such that a surface property may be altered and the reflected electric field can be changed.

The surface property of the unit cells may be determined from, and controlled using, an electrical property of the RIS unit cells. The electrical property may be indicative of the change in phase of the reflected electromagnetic waves received at the surface of the RIS. The electrical property may be a surface impedance. The electrical property may, alternatively, be a capacitance, resistance, or inductance of the RIS unit cells. Where capacitance is used the measurement is time dependent, although this is not the case for impedance, resistance or inductance.

It is important that as much of the RIS surface as possible has a controllable surface impedance and is covered by a unit cell. The unit cell's front face may therefore extend over the inset region of the flexible framework, nearly up to a mid-way line of each hinge. In this way the RIS can be both conformal with the non-planar surface (up to the length scale of the unit cells) and also be entirely controllable with semi-continuous unit cells. The small area of exposed supporting framework may be non-reflecting which may simply contribute to a small overall attenuation in reflected power.

Optionally, each unit cell may be produced with electrical contacts that align with wiring contacts in the flexible framework so that unit cells can be swapped out in the event of a failure. Although the unit cells can be mass-produced and inexpensive, they are nevertheless active electronics and at risk of failure and damage. As unit cells fail, the overall performance of the RIS may necessarily degrade, even if the controller may be able to compensate, since there may be fewer degrees of freedom available to optimize.

FIG. 2b shows an example connection between the unit cell 211 and the corresponding well 210 in the flexible framework. The electrical contacts 215 may include electrical contacts 215a, 215b, 215c, 215d, 215e, and 215f. These electrical contacts 215 on the bottom surface of the unit cell 211b may be matched with their corresponding electrical contacts at the inner surface of the well 210. The corresponding electrical contacts of the well 210 may include electrical contacts, 216a, 216b, 216c, 216d, 216e, and 216f.

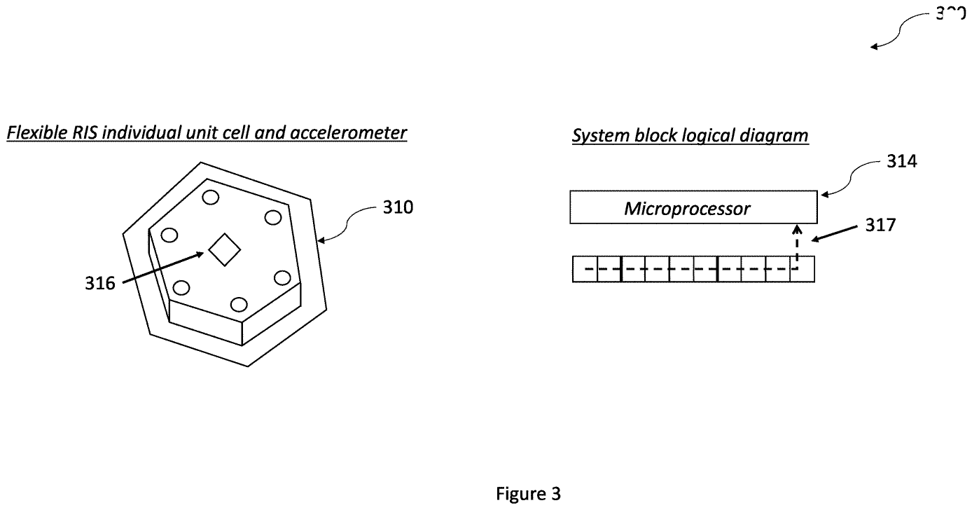

As shown in FIGS. 2a and 2b, each unit cell includes, or is connected to, a microprocessor 214. The microprocessor may be configured to communicate with each accelerometer (discussed in relation to FIG. 3) to receive accelerometer data of the plurality of RIS unit cells.

Optionally, the microprocessor may also be configured to monitor an electrical property of the RIS, such as surface impedance. In some embodiments, the microprocessor may be configured to measure a capacitance variation of each unit cell in response to an applied voltage. Optionally the microprocessor may measure multiple electrical properties of the RIS and combine these measurements, using weightings for each property, to derive a value indicative of the change in phase of electromagnetic waves received at the RIS unit cell.

In order to determine an operating condition of the RIS, accelerometers may be used to provide accelerometer data of the plurality of RIS unit cells. Each accelerometer may be configured to detect accelerometer data for at least one of the RIS unit cells. In some embodiments, each RIS unit cell, or local cluster of RIS unit cells, may contain an accelerometer integrated circuit (IC). Each accelerometer IC may communicate accelerometer data back to a microprocessor-based control system over a digital bus, such as I2C, 1-wire, CANBUS etc.

FIG. 3 shows a schematic diagram 300 of a configuration of a unit cell 310 including, or being connected to, an accelerometer 316. The accelerometer 316 may be coupled to the unit cell 310 at a bottom side. The accelerometer 316 at each unit cell may be coupled to a microprocessor 314 to provide orientation data to a microprocessor-based control system through a digital bus 317.

Optionally an internal wiring pattern formed by the data bus 317 may be a pre-determined pattern, such as a concentric wiring pattern, that is known by the controller. With a known wiring pattern, the controller may be able to identify all neighboring unit cells for a given unit cell. The controller may receive data from each unit cell identified by its own electronic ID. An order of arrival of the data bus 317 of each unit cell's data may inform the controller where each unit cell is along the wiring pattern and, given knowledge of the connectivity of the unit cells (e.g. hexagonal honeycomb pattern), the controller can be configured to deduce the connectivity (nearest neighboring unit cells) for all the unit cell IDs. Nearest neighboring unit cells may tend to move in a broadly similar manner, due to the fact that they are physically connected to each other. Such knowledge of all the unit cells' separate motions together with their connectivity may be a further aid to understanding the overall movement of the extended RIS.

Accelerometer integrated circuits (ICs) are widely available. Accelerometer ICs provide a digital signal including accelerometer data that may comprise, as a minimum:
i) rate of change of velocity on three-axis; and
ii) inclination of the accelerometer IC itself and thus the immediate structure, or flexible part of that it is affixed to.

The microprocessor 314 and its software may use inclination data and known predetermined curvature of the non-planar surface to calculate and determine an orientation of the flexible RIS structure with respect to this surface.

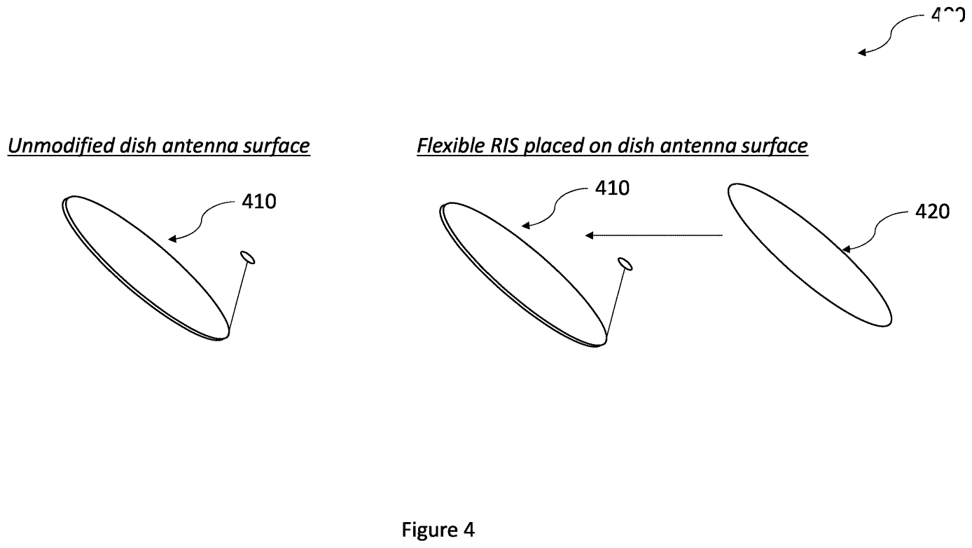

To implement a flexible RIS solution, the flexible RIS framework may be placed over a non-planar surface. FIG. 4 shows dish antenna 410 and a flexible RIS 420 which may be placed over a concave surface of the dish antenna 410 (i.e. the dish).

If the dish antenna 410 is essentially static, then the accelerometers of the plurality of RIS unit cells may only need to operate during the initial set-up phase to inform the controller of the orientation of each unit cell. However, if the dish antenna 410 is in motion or being shaken, then the accelerometers may inform the controller of the orientation of the RIS during operation to aid active beam control. In some embodiments, the accelerometers may continuously inform the controller of the orientation of the RIS.

A key property of a RIS is that it is programmable after deployment. This may be controlled by the controller using a control algorithm. The operation of a RIS can be split into two phases that are executed periodically:
Control and programming phase: the necessary environmental information for configuring the operation of the RIS may be estimated and it may be configured for subsequent operation; and
Normal operation phase: the RIS is already configured and assists the transmission of other devices throughout the network.

When the accelerometer is operated at each unit cell, the orientation data provided by the accelerometers may be used by the RIS controller to detect at least four categories of motion status of the underlying non-planar surface. The four categories are discussed as follows.

A first category may occur when the flexible RIS is conformed to an underlying antenna surface that is static or moving with a constant velocity. The RIS controller may be activated and enter its initial “control and programming phase”. In this phase, velocity and inclination of all unit cells may be recorded based on the accelerometer data and unit cell identification that it receives over the digital bus from the RIS. If the underlying antenna surface is essentially rigid with a stable orientation and the flexible RIS is not shifting position relative to the antenna surface, then the velocity of all unit cells may be substantially equal. The RIS controller may therefore calculate the relative orientation of all the unit cells. Antenna vibration (e.g. due to irregular motion) or changes in orientation (e.g. due to spinning) will complicate this calculation but it is still possible for the RIS controller to determine relative orientation within accuracy limits.

A second category may occur when the flexible RIS shifts position with respect to the underlying antenna surface. The flexible RIS may be firmly fixed to the antenna surface at several “clamp” points around the edge of the dish to avoid slipping off or flapping. The unit cells closest to these clamps may move as if rigidly attached to the antenna surface, whereas more distant unit cells may have more freedom of movement due to the flexibility of the RIS. Therefore, in the normal operation phase, the RIS controller may be able to detect the “clamped” unit cells since they will all show substantially identical velocity and orientation changes. The “unclamped” unit cells may vibrate and ripple to some degree, with increasing amplitude as they are more distant from the clamps. Therefore, when the velocities of the “clamped” unit cells are substantially equal to each other but are different to the velocities of the “unclamped” unit cells, the RIS controller may determine that the RIS is partially attached to the antenna surface.

A third category may occur when the underlying antenna surface changes its orientation with respect to the transmitter and receiver. In normal operation, assuming the antenna surface and the RIS are essentially rigid and fixed to each other, then when the antenna surface changes orientation (e.g. spins) then the relative orientation of the unit cells stays the same but there will be distribution of velocity changes across the unit cells. In this way, the RIS controller may determine the orientation change of the antenna surface.

A fourth category may occur when the underlying antenna surface distorts or vibrates. If the RIS controller determines that the initially-calculated relative orientation of the unit cells is changing during normal operation, then the RIS is distorting. This can be due to the flexible RIS vibrating around the fixed clamps on a rigid antenna surface, or the antenna surface itself is distorting. Both the flexible RIS and the antenna surface may also be vibrating and distorting at the same time. The frequency of vibrations may differ due to the different materials of the antenna and the flexible RIS. For example, the antenna surface may be a dish comprised of rigid metal, having a relatively fast period of vibration whereas the RIS may be comprised generally of soft resin having a relatively slow period of vibration.

The relative changes in velocity and orientation of any “clamped” unit cells may also reveal any edge deformation of the antenna surface.

Subsequently, the microprocessor and its software may detect any of these categories of movement, perform calibrations and provide feedback into the RIS programming phase which may optimize the wireless system's effectiveness.

Optionally, the RIS controller may be configured to determine a change in operating condition based on the change in orientation of the RIS unit cells and to adjust one or more operational parameters to compensate for the change in orientation.

Optionally, adjustments to operating parameters made by the controller may be implemented by changing a control voltage of each unit cell. In particular, a certain set of control voltages configured by the controller may determine the surface impedance of the RIS. Accordingly, each unit cell of the RIS may reflect an incident signal with a certain phase and amplitude, which may coherently combine with the reflections from all the other unit cells to create the desired reflected beam. Optionally, when the controller, based on the accelerometer data, detects that one or more unit cells have changed position relative to the incident RF wavefront, the controller may be configured to know that this distance change results in the incident phase being different such that the controller can correct for this in the reflected phase from each unit cell.

In some embodiments, the RIS may be conformed to the dish of a dish antenna for RF communications with a remote satellite. In order to set up the RIS configuration to aid communication between the ground-based satellite dish and the remote satellite, the RIS controller can periodically calibrate the status of the RIS itself, communicate with the remote satellite to confirm the results of its configuration and then spend the majority of its time in its normal operation phase.

Conventionally, in order to model the electromagnetic response of an arbitrarily curved metasurface, Maxwell's equations may be applied along boundary conditions by approximating “locally flat” sub regions of the surface. The mathematical feasibility to model the electromagnetic response of an arbitrarily curved metasurface is described by Wu, K., Coquet, P., Wang, Q. J. et al. in “Modelling of free-form conformal metasurfaces”, Nat Commun 9, 3494 (2018), available at https://doi.org/10.1038/s41467-018-05579-6. Such modelling may only be useful for a few tightly controlled special cases, such as lens designs. In practice, a brute force search may be initially used and enhanced by machine-learning and would not need to attempt to model the surface currents within the unit cells.

When each unit cell of the RIS has been overlaid on some arbitrary underlying surface, then an incident plane electromagnetic wave may reach each unit cell with a different and arbitrary phase difference. The challenge is to calculate the phase change that has to be added by each individual unit cell to its small part of the reflected wave so as to orchestrate the summed reflections in the desired wave. For example, a plane wave may be incident from +30 degrees, whereas a reflected beam may be required to reflect off at −45 degrees and come to a focus 3 km away at a remote receiver, using 1000 unit cells overlaid on a surface.

With complete knowledge of the underlying surface, the correct voltage settings required for all the unit cells in order for the RIS to operate as desired could in theory be calculated a priori to get a specific distribution of phase shifts. However, it may be simpler to search through all the different combinations of voltage settings for the unit cells and see what improves the signal strength at the remote receiver. Various search algorithms may be used (e.g. evolutionary or simulated annealing) that will find the voltage settings that are close to optimal for the set of unit cells making up the RIS, given the particular underlying surface, incident wave and remote receiver. This brute force search approach may work but may be slow.

To avoid repeating such a brute force search every time, a “codebook”, or database or table, of sets of voltage settings that have been found to work in the past may be built up and machine learning may be used to identify which starting configuration to be selected for each new situation and then the likely search patterns to use subsequently. A brute force search enhanced by machine-learning may involve initially trying every possible combination of voltage settings to see what settings improve operation and then learning from experience, which may be computationally expensive. Communication with the remote receiver is preferred, at least in an initial training phase and periodically thereafter.

A brute force search enhanced by machine-learning will achieve the desired beam-shaping, so long as a remote receiver can report back to the controller on how each change to the RIS operating parameters affects the received signal during a training phase. This works for directing a beam in a particular direction and also for shaping or steering the radiation pattern. Over time, the machine-learning algorithm will learn which types of voltage patterns result in appropriate operational results such as beam nulls, or tighter main beams, or smaller side lobes. This requires the distribution of functioning unit cells to remain unchanged for much longer than the training period or else the ML technique can not converge on a suitable solution.

The RIS controller may use the amplitude and frequency of the unit cells' changes in relative orientation and velocity to detect a vibrating RIS, a spinning antenna surface, and a distorting antenna surface. If the antenna is moving, then it is likely that all of these types of motion will be occurring simultaneously to some degree and the accelerometer data received by the RIS controller should be sufficient to allow the RIS controller to distinguish variations from the initially-learnt RIS orientation.

With a sufficiently long initial training phase, then a large number of parameters can be varied (e.g. relative orientation of remote satellite to antenna surface with different antenna/RIS distortions and vibrations). The RIS controller may initially learn which settings result in beam steering in a particular direction and couple this with the accelerometer data to maintain a constant beam direction. However training time may be limited, so the control algorithm may need to use ML to compile a codebook quickly based on gross orientation data only assuming an undistorted RIS, and then use a “hard-coded” approach to compensate for distortions away from the initial surface shape. This hard-coded approach may simply calculate the phase shift required to compensate for any measured unit cell displacement (e.g. if a unit cell is currently 3% of a wavelength away from the relative position it had during the training phase, then 3% of 2π is added to the phase shift from that unit cell at that moment in time).

If too many variables change, such as antenna shape, RIS damage, satellite orientation, then feedback from the remote satellite may show that performance of the RIS is falling below an acceptable limit, so then there will be no alternative to starting a new training phase.

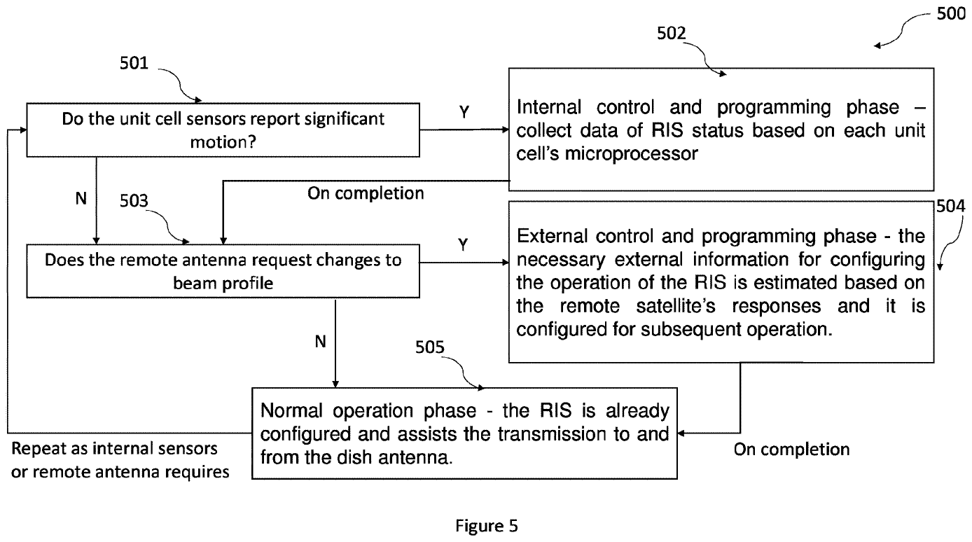

FIG. 5 shows a flowchart 500 which summarizes a method of configuration of the RIS at a control and programming phase, and a normal operation phase taking any motion status in unit cells into account. The control and programming phase may be further split into two phases, namely an internal control and programming phase and an external control and programming phase. In the internal control and programming phase, necessary environmental information for configuring the operation of the RIS may be estimated based on each microprocessor of the plurality of unit cells and it is configured for subsequent operation. In the external control and programming phase, the necessary external information for configuring the operation of the RIS may be estimated based on the remote receiver's (e.g. satellite) responses and it is configured for subsequent operation. In the normal operation phase, the RIS is already configured and assists the transmission to and from the dish antenna.

At 501, the controller may be configured to assess based on the detected accelerometer data in one or more unit cells. If change in motion is detected, an internal control and programming phase 502 may be carried out to collect data of RIS status based on each microprocessor connected to each unit cell of the plurality of unit cells of the RIS. When such internal programming phase is completed, or there is no significant change in motion detected, the controller may be configured to further assess if the remote antenna requests changes to beam profile at 503. If yes, an external control and programming phase may be carried out at 504. A set of external information for configuring the operation of the RIS may be estimated based on the remote satellite's responses and it may be configured for subsequent operation. When the external programming phase is completed or there is no request for changing the beam profile, a normal operation phase 505 may be then carried out at 505. In this phase, the RIS may be already configured and may assist the communications to and from the dish antenna. The operations at 501 to 505 may be repeated in response to an internal monitoring of the unit cells or a remote request from the antenna.

The method of FIG. 5 is described in relation to communication with a remote satellite, but it may be applied where communication to any appropriate remote transceiver device is implemented.

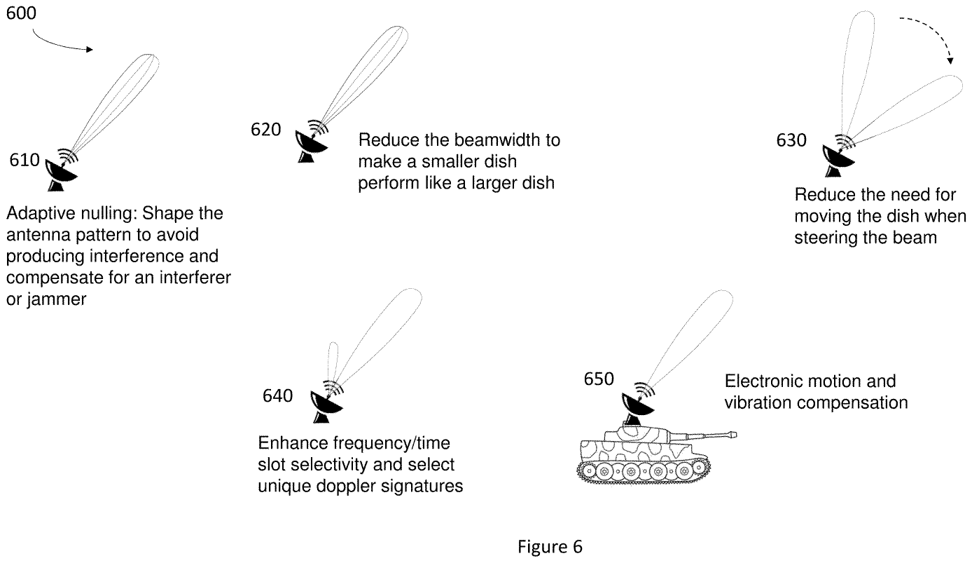

Embodiments can support various distinct performance benefits for a dish antenna. FIG. 6 shows five example advantages that may be achieved with embodiments of the disclosure, namely adaptive nulling, tighter beam with smaller dish, less dish movement, better selectivity and antenna motion compensation.

With adaptive nulling 610 it is possible to control gaps in the antenna pattern where interference will not be transmitted to or received from, allowing greater density of antennas and improved security against jamming. Adaptive nulling has been successfully used by array antennas to place nulls in the direction of interference sources, thereby minimizing the degradation caused by the interference. The main beam shape, angular locations of the nulls, and the sidelobe level are controlled by precisely setting the phase excitations of each array element. A constrained optimization is used to control the directionality of a single null toward the interfering directions by controlling the phase-only of the element excitations.

As shown in item 620, either the same beam width can be achieved with a smaller dish making it more mobile or pack more densely in a ground station, or the same dish can have a tighter beam with less interference.

Less dish movement 630 can be achieved. The need for dish movement can be reduced or even avoided by using electronic beam steering, to reduce the cost and weight of large dishes. Fine-tuning of angle can be done electronically, with coarse tuning being performed mechanically.

Better selectivity 640 can be achieved. Programmable and adaptive time and frequency-specific gain can be used to distinguish a known satellite with known position and motion from noise and jamming, for improved sensitivity and security.

Motion and vibration compensation 650 can be achieved. Any change of an operating condition due to a change in motion or vibration (e.g. velocity and orientation) of the underlying antenna surface, or a vehicle (e.g. a vehicle shown in item 650 in FIG. 6) that the antenna is positioned on, can be compensated by adjusting one or more operational parameters based on the operating condition. Any shift in position of the flexible RIS with respect to the underlying antenna surface or distortion of the RIS can also be detected and adjusted to compensate such changes in the RIS.

Embodiments can be used to optimize the above-mentioned performance benefits based on the unit cell orientation detection in four operational scenarios.

A first scenario is when the flexible RIS is first installed over the underlying antenna surface. The RIS may be fastened to the underlying antenna in a variety of possible orientations depending on the fastening mechanism.

A second scenario is when the flexible RIS shifts position with respect to the underlying antenna surface. The RIS may be fastened to the underlying antenna around the edge of the antenna and be able to distort as the antenna is shaken.

A third scenario is when the underlying antenna surface changes its orientation with respect to the transmitter and receiver. The antenna may be in jostling motion on a vehicle.

A fourth scenario is when the underlying antenna surface distorts or vibrates. The shape of the antenna may bend and bulge as it is shaken or moved.

Although described in relation to a reflective RIS, the embodiments described herein may be applied with any other suitable form of RIS including a transmissive RIS in which the EM wave passes through the RIS and its phase is altered during its passage. For example, a conformal RIS could be a transmissive RIS placed on a non-conducting non-planar surface positioned between the transmitter and receiver.

Other embodiments will be apparent to those skilled in the art from consideration of the specification and practice of the embodiments disclosed herein. It is intended that the specification and examples be considered as exemplary only.

In addition, where this application has listed the steps of a method or procedure in a specific order, it could be possible, or even expedient in certain circumstances, to change the order in which some steps are performed, and it is intended that the particular steps of the method or procedure claims set forth herein not be construed as being order-specific unless such order specificity is expressly stated in the claim. That is, the operations/steps may be performed in any order, unless otherwise specified, and embodiments may include additional or fewer operations/steps than those disclosed herein. It is further contemplated that executing or performing a particular operation/step before, contemporaneously with, or after another operation is in accordance with the described embodiments.

The methods described herein may be encoded as executable instructions embodied in a computer readable medium, including, without limitation, non-transitory computer-readable storage, a storage device, and/or a memory device. Such instructions, when executed by a processor (or one or more computers, processors, and/or other devices) cause the processor (the one or more computers, processors, and/or other devices) to perform at least a portion of the methods described herein. A non-transitory computer-readable storage medium includes, but is not limited to, volatile memory, non-volatile memory, magnetic and optical storage devices such as disk drives, magnetic tape, compact discs (CDs), digital versatile discs (DVDs), or other media that are capable of storing code and/or data.

Where a processor is referred to herein, this is to be understood to refer to a single processor or multiple processors operably connected to one another. Similarly, where a memory is referred to herein, this is to be understood to refer to a single memory or multiple memories operably connected to one another.

User devices can include, without limitation, static user devices such as PCs and mobile user devices such as smartphones, tablets, laptops and smartwatches.

The methods and processes can also be partially or fully embodied in hardware modules or apparatuses or firmware, so that when the hardware modules or apparatuses are activated, they perform the associated methods and processes. The methods and processes can be embodied using a combination of code, data, and hardware modules or apparatuses.

Receivers and transmitters as described herein may be standalone or may be comprised in transceivers. A communication link as described herein comprises at least one transmitter capable of transmitting data to at least one receiver over wireless communication channels.

1. A reconfigurable intelligent surface that can be conformed to a non-planar surface, the RIS comprising:
a plurality of RIS unit cells;
a plurality of accelerometers, each accelerometer configured to detect accelerometer data for at least one of the RIS unit cells; and
a controller configured to determine an operating condition of the RIS based on the detected accelerometer data of the at least one RIS unit cell and to adjust one or more operational parameters of the RIS based on the operating condition,
wherein each RIS unit cell comprises a dedicated accelerometer configured to detect the accelerometer data of the respective RIS unit cell.

2. The RIS according to claim 1, wherein:
the plurality of accelerometers are configured to measure an initial orientation of each of the plurality of RIS unit cells and a subsequent orientation of each of the plurality of RIS unit cells; and
the controller is configured to determine a change in the operating condition based on a change in the orientation of at least some of the RIS unit cells and to adjust one or more operational parameters of the RIS to compensate for the change in the orientation.

3. The RIS according to claim 1, wherein the controller is configured to determine the operating condition of the RIS by determining when velocities of the RIS unit cells are substantially equal and therefore indicating that the RIS is conformed to a non-planar surface that is static or moving with constant velocity.

4. The RIS according to claim 1, wherein the controller is configured to determine the operating condition of the RIS by determining when velocities of a first subset of the RIS unit cells are substantially equal to one another and determining when velocities of a second subset of the RIS unit cells, consisting of RIS unit cells not found in the first subset, are different from the velocities of the RIS unit cells in the first subset, therefore indicating that the RIS is partially attached to a non-planar surface.

5. The RIS according to claim 1, wherein the controller is configured to determine the operating condition of the RIS by determining when the relative orientation of the RIS unit cells stays the same and determining when there is a distribution of velocity changes across the RIS unit cells therefore indicating that the RIS is mounted on a non-planar surface that is changing orientation.

6. The RIS according to claim 1, wherein the controller is configured to determine the operating condition of the RIS by determining when an initially calculated relative orientation of the RIS unit cells is changing, indicating that the RIS is distorting.

7. The RIS according to claim 1, wherein the controller is configured to adjust a phase shift distribution across the RIS based on the determined operating condition of the RIS.

8. The RIS according to claim 1, wherein the controller is configured to determine an adjustment to the one or more operational parameters by looking up pre-determined settings based on the detected accelerometer data.

9. The RIS of claim 8, wherein the predetermined settings are determined using machine learning, wherein the machine learning is performed based on feedback from a receiver that is arranged to receive a transmission from an antenna on which the RIS is mounted, the feedback indicating whether performance of the antenna is improved.

10. A RIS according to claim 1, wherein each RIS unit cell is hinged with at least one neighboring RIS unit.

11. A RIS according to claim 1, further comprising a plurality of RIS unit sockets, each RIS unit socket configured to receive a RIS unit cell of the plurality of RIS unit cells, wherein a shape of the RIS unit socket and a shape of the RIS unit cell are configured such that the RIS unit cell extends to a periphery of the RIS unit socket, and wherein the plurality of RIS unit cells are removable.

12. An antenna comprising:
a non-planar antenna surface; and
the RIS of claim 1, wherein the RIS conforms to the non-planar antenna surface.

13. A method of controlling the antenna of claim 12, comprising controlling the RIS to improve antenna performance.

14. A method of controlling the antenna of claim 12, the method comprising controlling the RIS to compensate for motion of the antenna based on a detected orientation of each RIS unit.
